(19) United States
(12) Patent Application Publication
(10) Pub. No.: US 2015/0296183 A1
(43) Pub. Date: Oct. 15, 2015

(54) OUTSIDE SURVEILLANCE APPARATUS IN WHICH INTERPHONE AND TV ARE INTERLINKED AND CONTROL METHOD USING THE SAME

(71) Applicant: Hee Moon CHO, Seoul (KR)

(72) Inventor: Hee Moon CHO, Seoul (KR)

(21) Appl. No.: 14/251,821

(22) Filed: Apr. 14, 2014

(51) Int. Cl. H04N 7/18; H04M 1/725; H04N 5/44

(52) U.S. Cl. CPC H04N 7/18; H04N 5/4403; H04M 1/72513

(57) ABSTRACT

An outside surveillance apparatus and a control method using the same. A door lock is disposed on a door so as to be locked or unlocked. An interphone disposed on an outer wall includes a button which a visitor can press and a camera which takes an image of the visitor. A TV is interlinked with the interphone, and displays the image taken using the camera on a screen in response to the button being pressed. A set-top box has an announcement display section, which is configured to display a number of announcements in response to the button being pressed. A remote control remotely controls the TV in order to select a broadcast channel and select one of the number of announcements. The remote control has a select button to select one of the number of announcements and an unlock button to unlock the door lock.

### BACKGROUND OF THE INVENTION

1. Field of the Invention

The present invention relates, in general, to an outside surveillance apparatus in which an interphone and a TV are interlinked and a control method using the same, and more particularly, to an outside surveillance apparatus in which an interphone and a TV are interlinked, whereby, when a signal is generated from an interphone, an outside person such as a visitor can be identified through the TV screen, the identification of the visitor can be confirmed and suitable replies can be made using a reply function based on recorded announcements so that the voice of a user who is inside a house is not revealed. The present invention can consequently remove a feeling of uneasiness when a weak or vulnerable person, such as a woman or an elderly person, responds to a visitor, and thus the present invention can prevent the weak or vulnerable person from being subjected to crime.

2. Description of the Related Art

In general, interphones used at homes are divided into system parts which are provided indoor and outdoor. The system parts which are divided in this manner are connected via wires. Therefore, when an outside person such as a visitor presses a button on the outer wall of the house and asks permission to enter, a person inside the house recognizes the visitor based on his or her voice or both the image and voice of the visitor. That is, the person inside the house who operates the interphone recognizes the visitor based on a vocal conversational exchange or by the image or both, and then opens the front door by pressing a door button which is disposed inside the house so that the visitor can enter.

The door button inside the house is disposed close to the front door or disposed on a phone for use. According to the approach in which the door button is disposed on the phone, an extension line of a home telephone is used. When a bell at the front door is pressed, the home telephone is called, so that a communication line can be established between the telephone and the outside interphone. It is also possible to automatically open the front door using specific codes entered via the telephone.

However, according to this interphone system, when the distance between the front door and the indoor telephone is large, a long extension line must be used. Because of this problem, the interphone system is generally disposed at a position close to the front door.

This system requires a user to move to the telephone close to the front door in order to recognize the visitor. This is inconvenient when the user is watching TV.

There is another problem in that the indoor structure of the house must be changed in order to conceal lines that connect components of the interphone system.

Korean Laid-Open Patent Publication No. 10-1999-0047971 disclosed a technology related to a TV set having a door phone in which a visitor can be recognized.

According to this related-art document, when a visitor presses a call button of a door phone which is provided on a front door, the TV senses it and allows a user to view an image signal by supplying power to a signal indicator or the like. A camera provided in the door phone on the front door is operated due to power supplied thereto, and takes images of the visitor. The images of the visitor are displayed on the screen of the TV through picture-in-picture (PIP) processing, so that the user can see the visitor.

However, the related-art interphone system requires the user to talk with the outside visitor using an indoor microphone in order to ask who the visitor is after seeing the visitor on an indoor monitor or the TV screen.

This direct voice conversation allows the visitor to guess the age or gender of the user who is inside the house, leading to a problem in that the personal information of the user may be exposed. The personal information leaked in this manner may encourage a criminal to proceed with a crime, and thus vulnerable persons, such as a child, a woman or an elderly person, may be confronted with a dangerous situation.

The information disclosed in the Background of the Invention section is only for the enhancement of understanding of the background of the invention, and should not be taken as an acknowledgment or any form of suggestion that this information forms a prior art that would already be known to a person skilled in the art.

### RELATED ART DOCUMENT

Patent Document 1: Korean Laid-Open Patent Publication No. 10-1999-0047971

### SUMMARY OF THE INVENTION

Accordingly, the present invention has been made keeping in mind the above problems occurring in the related art, and the present invention is intended to propose an outside surveillance apparatus in which an interphone and a TV are interlinked. When a signal is generated from the interphone, an outside person such as a visitor can be observed through the TV screen The identification of the visitor can be confirmed and suitable replies can be made using a reply function based on recorded announcements so that the voice of a user who is inside a house is not revealed. This can reduce the feeling of uneasiness when a vulnerable person, such as a woman or an elderly person, responds to a visitor at the door, and prevent the vulnerable persons from being subjected to crime. In addition, it can enable speech-impaired persons to easily respond to a visitor.

In order to achieve the above object, according to one aspect of the present invention, there is provided an outside surveillance apparatus that includes: a door lock which is disposed on a door so as to be locked or unlocked; an interphone which is disposed on an outer wall, and includes a button which a visitor can press and a camera which takes an image of the visitor; a TV which is disposed indoor such that a user can watch a broadcast program, wherein the TV is interlinked with the interphone and displays the image taken using the camera on a screen in response to the button being pressed; a set-top box which has an announcement display section therein, the announcement display section being configured to display a number of announcements in response to the button being pressed; and a remote control capable of remotely controlling the TV in order to select a broadcast channel and select one of the number of announcements stored in the announcement display section, wherein the remote control has a select button with which one of the number of announcements is selected and an unlock button with which the door lock is unlocked.

According to an embodiment of the present invention, the set-top box may include: a main circuit section, wherein the main circuit section has an image input section which is connected to the camera of the interphone and to which an image signal is inputted, a voice input section which is connected to a microphone of the interphone and to which a voice signal is inputted, and a button signal input section which is connected to the button and to which a button signal is inputted in response to the button being pressed; and a conversion circuit section which is connected to the main circuit section, and transfers the image signal, the voice signal and the button signal.

The TV may display the outside image taken using the camera of the interphone on a divided portion of the screen using a picture-in-picture function.

Examples of the number of announcements may include: “Who is it?” “ I am out on,” “Please, visit next time,” “No thanks,” etc.

The set-top box may have a recording section which allows the user to record his/her own voice announcements.

According to the present invention as set forth above, it is possible to recognize a visitor through the TV screen when a signal is generated from the interphone while watching the TV. The identification of the visitor can be recognized and suitable replies can be made using a reply function based on recorded announcements. This prevents the visitor from guessing the gender or age of the user who is inside the house, thereby preventing the user inside the house from being subjected to crime. Speech-impaired persons can easily respond to a visitor without revealing the user's impairment.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a view showing the configuration of an outside surveillance apparatus in which an interphone and a TV are interlinked according to an exemplary embodiment of the invention;

FIG. 2 is a view showing the operation relationship of the outside surveillance apparatus in which an interphone and a TV are interlinked according to an exemplary embodiment of the invention; and

FIG. 3 is a flowchart showing a control method using the outside surveillance apparatus in which an interphone and a TV are interlinked according to an exemplary embodiment of the invention.

### DETAILED DESCRIPTION OF THE INVENTION

Reference will now be made in greater detail to an exemplary embodiment of the present invention, an example of which is illustrated in the accompanying drawings. Wherever possible, the same reference numerals will be used throughout the drawings and the description to refer to the same or like parts.

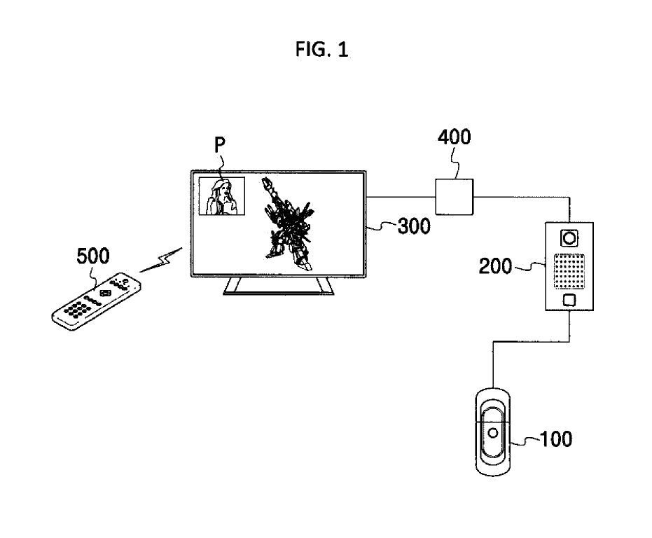

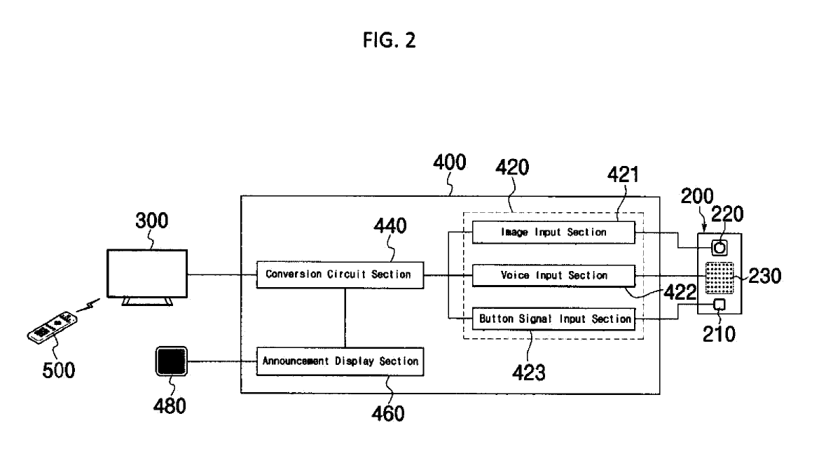

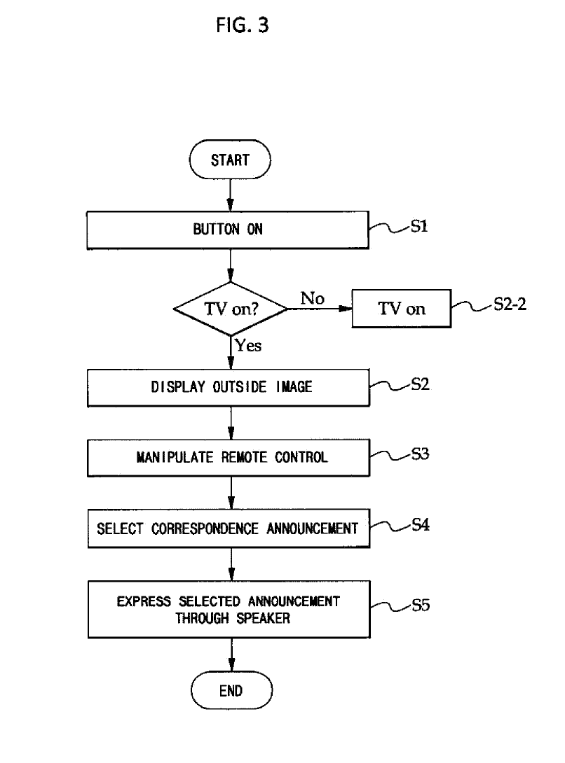

Among the accompanying drawings, FIG. 1 is a view showing the configuration of an outside surveillance apparatus in which an interphone and a TV are interlinked according to an exemplary embodiment of the invention, FIG. 2 is a view showing the operation relationship of the outside surveillance apparatus in which an interphone and a TV are interlinked according to an exemplary embodiment of the invention, and FIG. 3 is a flowchart showing a control method using the outside surveillance apparatus in which an interphone and a TV are interlinked according to an exemplary embodiment of the invention.

As shown in FIG. 1 to FIG. 3, the outside surveillance apparatus in which an interphone and a TV are interlinked according to this exemplary embodiment includes a door lock 100, an interphone 200, a TV 300, a set-top box 400 and a remote control 500. The door lock 100 is disposed on a door, such as a front door, so as to be locked or unlocked. The interphone 200 is disposed on an outer wall, and includes a button 210 which an outside person, such as a visitor, can press and a camera which takes an image P of the visitor. The TV 300 is disposed indoor such that a user can watch broadcast program. The TV 300 is interlinked with the interphone, and displays the image P taken using the camera 220 on the screen in response to the button 210 being pressed. The set-top box 400 has an announcement display section 460 therein, the announcement display section 460 being configured to display a number of announcements in response to the button 210 being pressed. The remote control 500 can remotely control the TV 300 in order to select a broadcast channel and select one of the number of announcements stored in the announcement display section 460. The remote control 500 has a select button with which one of the number of announcements is selected and an unlock button with which the door lock 100 is unlocked.

The set-top box 400 includes a main circuit section 420 and a conversion circuit section 440. The main circuit section 420 includes an image input section 421 which is connected to the camera 220 of the interphone 200 and to which an image signal is inputted, a voice input section 422 which is connected to a microphone of the interphone 200 and to which a voice signal is inputted, and a button signal input section 423 which is connected to the button 210 and to which a button signal is inputted in response to the button 210 being pressed. The conversion circuit section 440 is connected to the main circuit section 420, and transfers the image signal, the voice signal and the button signal.

The TV 300 displays an outside image, which has been taken using the camera 220 of the interphone 200, in an inset window of the screen using a picture-in-picture (PIP) function.

The number of announcements which is to be displayed by the announcement display section 460 includes a variety of correspondence announcements which are required for a variety of assumed circumstances. Examples of the number of announcements include: “Who is it?” “ I am out on,” “Please, visit next time,” “No thanks,” etc.

Of course, these announcement examples can be modified into a variety of other announcements.

In addition, the set-top box 400 has a recording section 480 with which a user can record his/her own voice announcements. Consequently, the user can set the outside surveillance apparatus according to his/her intentions and preference.

The corresponding announcements are expressed with a voice through a speaker 230 of the interphone 200. The voice outputted at this time is preferably a synthesized sound such that neither the gender nor the age of the user inside the house is recognizable.

Reference will now be made to a control method using the outside surveillance apparatus in which an interphone and a TV are interlinked according to an exemplary embodiment of the invention.

As shown in FIG. 3, the control method includes a first step S1 of turning on the interphone 200 in response to the button 210 of the interphone 200 being pressed by an outside person such as a visitor; a second step S2 of displaying an outside image obtained using the camera 220 of the interphone 200 in an inset window of the screen of the indoor TV that is turned on; a third step S3 in which the user, such as the resident, checks the visitor through the displayed image P and then manipulates the select button of the remote control 500; a fourth step S4 of displaying an announcement menu in response to the select button of the remote control being manipulated, thereby allowing the user to select an intended announcement; and a fifth step S5 of expressing the intended announcement via a prerecorded voice through the speaker 230 of the interphone 200 in response to the user selecting the intended announcement and then clicking the select button.

When the visitor turns on the interphone 200 by pressing the button 210 thereof at S1, the outside image obtained using the camera 220 is displayed on the screen of the indoor TV.

At S2, the image P is displayed in the inset window of the screen so that the user is not interrupted from watching the TV 300.

If the TV 300 is off, the switch of the TV 300 can be turned on in response to a button signal from the button 210 of the interphone 200 at S2-2.

It is therefore possible to control the turn-on operation of the TV 300 by transferring the button signal to an on/off switch controller which is disposed inside the TV 300.

In addition, an indoor speaker rings a bell in response to the on-operation of the button 210 such that the user can hear it.

At S3, the user checks the visitor through the expressed image P, manipulates the select button of the remote control 500 so that correspondence announcements are displayed. Afterwards, the user selects an intended announcement at S4.

When the select button is clicked after the intended announcement is selected, the intended announcement is expressed via a prerecorded voice through the speaker 230 of the interphone 200 at S5.

For instance, the voice announcement, “Who is it?” is expressed in order to identify the visitor. The voice announcement is expressed in a sound that is synthesized such that any information that may suggest the gender or age of the user is not provided. This can consequently protect the privacy and safety of the user.

Afterwards the visitor discloses his/her identification and the purpose of the visit. Then, the user selects and clicks a correspondence announcement, which is then expressed via the prerecorded voice through the interphone.

This method of expressing the corresponding announcements according to the invention is used for the purpose of simple identification in the case in which only a child is in the house when adults are out of the house or in the case in which only an elderly person or a speech-impaired person is in the house. This method does not require a long conversation and requires that only a few simple correspondence announcements be expressed.

Although the exemplary embodiments of the present invention have been described for illustrative purposes, those skilled in the art will appreciate that various modifications, additions and substitutions are possible, without departing from the scope and spirit of the present invention as disclosed in the accompanying claims.

1. An outside surveillance apparatus comprising:
a door lock which is disposed on a door so as to be locked or unlocked;
an interphone which is disposed on an outer wall, and includes a button which a visitor can press and a camera which takes an image of the visitor;
a television which is disposed inside a room such that a user can watch a broadcast program, wherein the television is interlinked with the interphone and displays the image taken using the camera on a screen in response to the button being pressed;
a set-top box which has an announcement display section therein, the announcement display section being configured to display a number of announcements on the screen of the television in response to'the button being pressed, so that the user can make a response by selecting one of the number of announcements; and
a remote control for remotely controlling the television in order to select a broadcast channel and select one of the number of announcements stored in the announcement display section, wherein the remote control comprises a select button with which one of the number of announcements is selected and an unlock button with which the door lock is unlocked.

2. The outside surveillance apparatus according to claim I, wherein the set-top box comprises:
a main circuit section, wherein the main circuit section comprises an image input section which is connected to the camera of the interphone and to which an image signal is inputted, a voice input section which is connected to a microphone of the interphone and to which a voice signal is inputted, and a button signal input section which is connected to the button and to which a button signal is inputted in response to the button being pressed; and
a conversion circuit section which is connected to the main circuit section, and transfers the image signal, the voice signal and the button signal.

3. The outside surveillance apparatus according to claim 1, wherein the television displays the outside image taken using the camera of the interphone on a divided portion of the screen using a picture-in-picture function.

4. The outside surveillance apparatus according to claim 2, wherein the set-top box comprises a voice recording section which allows the user to personally record voice announcements.

5. A control method using the outside surveillance apparatus as claimed in claim 1, the control method comprising:
turning on the interphone in response to the button of the interphone being pressed by a visitor at an outside of the door;
displaying the outside image obtained using the camera of the interphone in a divided portion of the screen of the indoor television that is turned on, such that the user, inside a house checks the visitor through the displayed image and then manipulates the select button of the remote control;
displaying an announcement menu including a number of announcements stored in the set-top box on the screen of the indoor television in response to the select button of the remote control being manipulated, thereby allowing the user to select his or her desired one of the number of announcements; and
expressing the desired announcement in a prerecorded voice through a speaker of the interphone in response to the user selecting the desired announcement and then clicking the select button.

6. The control method according to claim 5, further comprising, if the television is off, turning on a switch of the indoor television in response to a button signal from the button of the interphone.

7. The control method according to claim 5, wherein the set-top box comprises:
a main circuit section, wherein the main circuit section comprises an image input section which is connected to the camera of the interphone and to which an image signal is inputted, a voice input section which is connected to a microphone of the interphone and to which a voice signal is inputted, and a button signal input section which is connected to the button and to which a button signal is inputted in response to the button being pressed; and
a conversion circuit section which is connected to the main circuit section, and transfers the image signal, the voice signal and the button signal.

8. The control method according to claim 5, wherein the television displays the outside image taken using the camera of the interphone on a divided portion of the screen using a picture-in-picture function.

9. The control method according to claim 7, wherein the set-top box comprises a voice recording section which allows the user to personally record voice announcements.
